(19) United States
(12) Patent Application Publication
(10) Pub. No.: US 2018/0194926 A1
(43) Pub. Date: Jul. 12, 2018

(54) BORON NITRIDE-CONTAINING THERMOPLASTIC COMPOSITION

(71) Applicant: Covestro Deutschland AG, Leverkusen (DE)

(72) Inventors: BIRTE SÄMISCH, Köln (DE); Rolf WEHRMANN, Krefeld (DE); Helmut Werner HEUER, Leverkusen (DE); Timo KUHLMANN, Leichlingen (DE)

(21) Appl. No.: 15/742,328

(22) PCT Filed: Jul. 5, 2016
(86) PCT No.: PCT/EP2016/065832

§ 371 Date: Jan. 5, 2018

(30) Foreign Application Priority Data
Jul. 8, 2015 (EP) 15175788.7

(51) Int. Cl. C08K 3/38; C08K 5/103; C08L 69/00

(52) U.S. Cl. CPC C08K 3/38; C08K 5/103; C08K 3/04; C08K 2003/385; C08K 2201/001; C08L 69/00

(57) ABSTRACT

The present invention relates to thermally conductive compositions based on a thermoplastic polymer and boron nitride. The compositions contain at least one diglycerol ester to improve flow. These compositions additionally have good heat distortion resistance, and so the compositions are especially usable for the production of heat sinks.

The present invention relates to thermally conductive, boron nitride-containing polymer compositions having good flowability and simultaneously good heat distortion resistance.

The conventional way of improving flow in the case of thermoplastic compositions is to use BDP (bisphenol A diphosphate), in amounts of up to more than 10.0% by weight, in order to achieve the desired effect. However, the addition of BDP in large amounts significantly lowers heat distortion resistance.

Improvement of the flowability of thermoplastic compositions is also accomplished by using other agents. For example, US 2008/153959 A1 describes compositions comprising a polymer and boron nitride, wherein the flowability of the compositions is improved by the addition of 10% by weight to 30% by weight of a graphite. Compositions of this kind are generally difficult to process because of the high contents of graphite and boron nitride. Moreover, the compositions claimed are frequently electrically conductive, which limits the use of the compositions.

However, the addition of graphite is in no way a guarantee that good flowability can be achieved. U.S. Pat. No. 7,723,419 B1, for instance, likewise describes thermoplastic compositions comprising boron nitride and graphite having a particle size of about 55 to 65 μm, but the compositions have generally inadequate flowability because of the particle size of the spherical boron nitride. Improvement of the flowability of the compositions claimed is not a topic of discussion.

Further agents for improving flowability are, for example, low molecular weight hydrocarbon resins and olefins, as described in US 2012/0217434 A1 for compositions comprising a polymer, a thermally insulating filler and a thermally conductive filler, the thermal conductivity of the compositions being at least 1 W/(m·K).

US 2014/077125 A1 describes a composition comprising thermoplastics, boron nitride prepared in situ, and a hard filler. Improvement of the flowability of the composition is not a topic of discussion.

It has now been found that, surprisingly, diglycerol esters are suitable for improving the flowability of boron nitride-containing thermoplastic compositions, especially those comprising polycarbonate as one or the sole thermoplastic. Diglycerol esters, by contrast with BDP, do not lead to lowering of the heat distortion resistance.

The invention therefore provides thermoplastic compositions comprising
(A) at least one thermoplastic polymer,
(B) boron nitride and
(C) at least one flow auxiliary selected from the group of the diglycerol esters.

The object is additionally achieved by mouldings, especially components of an electrical or electronic assembly, of an engine part or of a heat exchanger, for example lamp holders, heat sinks and coolers or cooling bodies for printed circuit boards, produced from such a composition.

The individual constituents of the compositions according to the invention are elucidated in detail below:

Component A

Thermoplastic polymers used are amorphous and/or semicrystalline thermoplastic polymers, alone or in a mixture, selected from the group of the polyamides, polyesters, polyphenylene sulphides, polyphenylene oxides, polysulphones, poly(meth)acrylates, polyimides, polyether imides, polyether ketones and polycarbonates. Preference is given in accordance with the invention to using polyamides or polycarbonates, very particular preference to using polycarbonates.

The compositions according to the invention preferably contain 27.8% to 90% by weight further preferably, 55.0% to 90.0% by weight and most preferably 70% to 90% by weight of thermoplastic polymer.

In one embodiment of the present invention, the thermoplastic polymer used is amorphous and/or semicrystalline polyamides. Suitable polyamides are aliphatic polyamides, for example PA-6, PA-11, PA-12, PA-4,6, PA-4,8, PA-4,10, PA-4,12, PA-6,6, PA-6,9, PA-6,10, PA-6,12, PA-10,10, PA-12,12, PA-6/6,6 copolyamide, PA-6/12 copolyamide, PA-6/11 copolyamide, PA-6,6/11 copolyamide, PA-6,6/12 copolyamide, PA-6/6,10 copolyamide, PA-6,6/6,10 copolyamide, PA-4,6/6 copolyamide, PA-6/6,6/6,10 terpolyamide, and copolyamide formed from cyclohexane-1,4-dicarboxylic acid and 2,2,4- and 2,4,4-trimethylhexamethylenediamine, aromatic polyamides, for example PA-6,1, PA-6,1/6,6 copolyamide, PA-6,T, PA-6,T/6 copolyamide, PA-6,T/6,6 copolyamide, PA-6,1/6,T copolyamide, PA-6,6/6,T/6,1 copolyamide, PA-6,T/2-MPMDT copolyamide (2-MPMDT=2-methylpentamethylenediamine), PA-9,T, copolyamide formed from terephthalic acid, 2,2,4- and 2,4,4-trimethylhexamethylenediamine, copolyamide formed from isophthalic acid, laurolactam and 3,5-dimethyl-4,4-diaminodicyclohexylmethane, copolyamide formed from isophthalic acid, azelaic acid and/or sebacic acid and 4,4-diaminodicyclohexylmethane, copolyamide formed from caprolactam, isophthalic acid and/or terephthalic acid and 4,4-diaminodicyclohexylmethane, copolyamide formed from caprolactam, isophthalic acid and/or terephthalic acid and isophoronediamine, copolyamide formed from isophthalic acid and/or terephthalic acid and/or further aromatic or aliphatic dicarboxylic acids, optionally alkyl-substituted hexamethylenediamine and alkyl-substituted 4,4-diaminodicyclohexylamine or copolyamides thereof, and mixtures of the aforementioned polyamides.

When polyamides are used, component A used is preferably semicrystalline polyamides having advantageous thermal properties. In this context, semicrystalline polyamides having a melting point of at least 200° C., preferably of at least 220° C., further preferably of at least 240° C. and even further preferably of at least 260° C. are used. The higher the melting point of the semicrystalline polyamides, the more advantageous the thermal behaviour of the compositions according to the invention. The melting point is determined by means of DSC.

Preferred semicrystalline polyamides are selected from the group comprising PA-6, PA-6,6, PA-6,10, PA-4,6, PA-11, PA-12, PA-12,12, PA-6,1, PA-6,T, PA-6,T/6,6 copolyamide, PA-6,T/6 copolyamide, PA-6/6,6 copolyamide, PA-6,6/6,T/6,1 copolyamide, PA-6,T/2-MPMDT copolyamide, PA-9,T, PA-4,6/6 copolyamide and the mixtures or copolyamides thereof.

Particularly preferred semicrystalline polyamides are PA-6,1, PA-6,T, PA-6,6, PA-6,6/6T, PA-6,6/6,T/6,1 copolyamide, PA-6,T/2-MPMDT copolyamide, PA-9,T, PA-4,6 and the mixtures or copolyamides thereof.

Preferred compositions according to the invention comprise, as component A, the polymer PA-4,6 or one of the copolyamides thereof.

Particularly preferred compositions according to the invention comprise exclusively polycarbonate as thermoplastic polymer.

Polycarbonates in the context of the present invention are either homopolycarbonates or copolycarbonates and/or polyestercarbonates; the polycarbonates may, in a known manner, be linear or branched. According to the invention, it is also possible to use mixtures of polycarbonates.

The thermoplastic polycarbonates including the thermoplastic aromatic polyestercarbonates have mean molecular weights M, (determined by measuring the relative viscosity at 25° C. in CH₂Cl₂ and a concentration of 0.5 g per 100 ml of CH₂Cl₂) of 20 000 g/mol to 32 000 g/mol, preferably of 23 000 g/mol to 31 000 g/mol, especially of 24 000 g/mol to 31 000 g/mol.

A portion of up to 80 mol %, preferably of 20 mol % up to 50 mol %, of the carbonate groups in the polycarbonates used in accordance with the invention may be replaced by aromatic dicarboxylic ester groups. Polycarbonates of this kind, incorporating both acid radicals from the carbonic acid and acid radicals from aromatic dicarboxylic acids in the molecule chain, are referred to as aromatic polyestercarbonates. In the context of the present invention, they are encompassed by the umbrella term of the thermoplastic aromatic polycarbonates.

The polycarbonates are prepared in a known manner from diphenols, carbonic acid derivatives, optionally chain terminators and optionally branching agents, with preparation of the polyestercarbonates by replacing a portion of the carbonic acid derivatives with aromatic dicarboxylic acids or derivatives of the dicarboxylic acids, according to the carbonate structural units to be replaced in the aromatic polycarbonates by aromatic dicarboxylic ester structural units.

Dihydroxyaryl compounds suitable for the preparation of polycarbonates are those of the formula (2)

HO—Z—OH (2),

in which
Z is an aromatic radical which has 6 to 30 carbon atoms and may contain one or more aromatic rings, may be substituted and may contain aliphatic or cycloaliphatic radicals or alkylaryls or heteroatoms as bridging elements.

Preferably, Z in formula (2) is a radical of the formula (3)

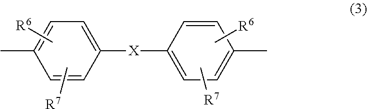

in which
R⁶ and R⁷ are each independently H, C₁- to C₁₈-alkyl-, C₁- to C₁₈-alkoxy, halogen such as Cl or Br or in each case optionally substituted aryl or aralkyl, preferably H or C₁- to C₁₂-alkyl, more preferably H or C₁- to C₈-alkyl and most preferably H or methyl, and
X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else C₆- to C₁₂-arylene which may optionally be fused to further aromatic rings containing heteroatoms.

Preferably, X is a single bond, C₁- to C₅-alkylene, C₂- to C₅-alkylidene, C₅- to C₆-cycloalkylidene, —O—, —SO—, —CO—, —S—, —SO₂—

or a radical of the formula (3a)

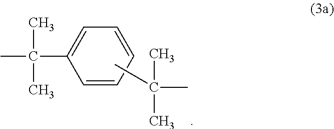

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulphides, bis(hydroxyphenyl) sulphones, bis(hydroxyphenyl) sulphoxides, 1,1′-bis(hydroxyphenyl)diisopropylbenzenes and the ring-alkylated and ring-halogenated compounds thereof.

Examples of diphenols suitable for the preparation of the polycarbonates for use in accordance with the invention include hydroquinone, resorcinol, dihydroxydiphenyl, bis(hydroxyphenyl)alkanes, bis(hydroxyphenyl)cycloalkanes, bis(hydroxyphenyl) sulphides, bis(hydroxyphenyl) ethers, bis(hydroxyphenyl) ketones, bis(hydroxyphenyl) sulphones, bis(hydroxyphenyl) sulphoxides, α,α′-bis(hydroxyphenyl)diisopropylbenzenes and the alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

These and further suitable diphenols are described, for example, in U.S. Pat. No. 2,999,835 A, 3 148 172 A, 2 991 273 A, 3 271 367 A, 4 982 014 A and 2 999 846 A, in German published specifications 1 570 703 A, 2 063 050 A, 2 036 052 A, 2 211 956 A and 3 832 396 A, in French patent 1 561 518 A1, in the monograph “H. Schnell, Chemistry and Physics of Polycarbonates, Interscience Publishers, New York 1964, p. 28 ff.; p. 102 ff.”, and in “D. G. Legrand, J. T. Bendler, Handbook of Polycarbonate Science and Technology, Marcel Dekker New York 2000, p. 72ff.”.

Only one diphenol is used in the case of the homopolycarbonates; two or more diphenols are used in the case of copolycarbonates. The diphenols employed, similarly to all other chemicals and assistants added to the synthesis, may be contaminated with the contaminants from their own synthesis, handling and storage. However, it is desirable to employ the purest possible raw materials.

The monofunctional chain terminators needed to regulate the molecular weight, such as phenols or alkylphenols, especially phenol, p-tert-butylphenol, isooctylphenol, cumylphenol, the chlorocarbonic esters thereof or acid chlorides of monocarboxylic acids or mixtures of these chain terminators, are either supplied to the reaction together with the bisphenoxide(s) or else added to the synthesis at any time, provided that phosgene or chlorocarbonic acid end groups are still present in the reaction mixture, or, in the case of the acid chlorides and chlorocarbonic esters as chain terminators, provided that sufficient phenolic end groups of the polymer being formed are available. Preferably, the chain terminator(s), however, is/are added after the phosgenation at a site or at a time when no phosgene is present any longer but the catalyst has still not been metered in, or are metered in prior to the catalyst, together with the catalyst or in parallel.

Any branching agents or branching agent mixtures to be used are added to the synthesis in the same manner, but typically before the chain terminators. Typically, trisphenols, quaterphenols or acid chlorides of tri- or tetracarboxylic acids are used, or else mixtures of the polyphenols or of the acid chlorides.

Some of the compounds having three or more than three phenolic hydroxyl groups that are usable as branching agents are, for example, phloroglucinol, 4,6-dimethyl-2,4,6-tri(4-hydroxyphenyl)hept-2-ene, 4,6-dimethyl-2,4,6-tri-(4-hydroxyphenyl)heptane, 1,3,5-tris(4-hydroxyphenyl)benzene, 1,1,1-tri-(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of any branching agents to be used is 0.05 mol % to 2 mol %, again based on moles of diphenols used in each case.

The branching agents can either be initially charged together with the diphenols and the chain terminators in the aqueous alkaline phase or added dissolved in an organic solvent prior to the phosgenation.

All these measures for preparation of the polycarbonates are familiar to those skilled in the art.

Aromatic dicarboxylic acids suitable for the preparation of the polyestercarbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulphone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids are the dicarbonyl dihalides and the dialkyl dicarboxylates, especially the dicarbonyl dichlorides and the dimethyl dicarboxylates.

The replacement of the carbonate groups by the aromatic dicarboxylic ester groups proceeds essentially stoichiometrically and also quantitatively, and so the molar ratio of the co-reactants is reflected in the final polyester carbonate. The aromatic dicarboxylic ester groups can be incorporated either randomly or in blocks.

Preferred modes of preparation of the polycarbonates for use in accordance with the invention, including the polyestercarbonates, are the known interfacial process and the known melt transesterification process (cf. e.g. WO 2004/063249 A1, WO 2001/05866 A1, WO 2000/105867, U.S. Pat. No. 5,340,905 A, U.S. Pat. No. 5,097,002 A, U.S. Pat. No. 5,717,057 A).

In the first case, the acid derivatives used are preferably phosgene and optionally dicarbonyl dichlorides; in the latter case, they are preferably diphenyl carbonate and optionally dicarboxylic diesters. Catalysts, solvents, workup, reaction conditions etc. for the polycarbonate preparation or polyestercarbonate preparation have been described and are known to a sufficient degree in both cases.

If the thermoplastic polymer of component A is a polycarbonate, preferably 28% to 89.8% by weight of polycarbonate, more preferably 54.7% to 89.8% by weight, based on the overall composition, is present.

Component B

According to the invention, boron nitride is used as component B.

In the compositions according to the invention, the boron nitride used may be a cubic boron nitride, a hexagonal boron nitride, an amorphous boron nitride, a partially crystalline boron nitride, a turbostratic boron nitride, a wurtzitic boron nitride, a rhombohedral boron nitride and/or a further allotropic form, preference being given to the hexagonal form.

The preparation of boron nitride is described, for example, in the publications U.S. Pat. No. 6,652,822 B2, US 2001/0021740 A1, U.S. Pat. No. 5,898,009 A, U.S. Pat. No. 6,048,511 A, US 2005/0041373 A1, US 2004/0208812 A1, U.S. Pat. No. 6,951,583 B2 and in WO 2008/042446 A2.

The boron nitride is used in the form of platelets, powders, nanopowders, fibres and agglomerates, or a mixture of the aforementioned forms.

Preference is given to utilizing a mixture of boron nitride in the form of discrete platelets and agglomerates.

Preference is likewise given to using boron nitrides having agglomerated particle size (D(0,5) value) of 1 μm to 100 μm, preferably of 3 μm to 60 μm, more preferably of 5 μm to 30 μm, determined by laser diffraction. In laser diffraction, particle size distributions are determined by measuring the angular dependence of the intensity of scattered light of a laser beam penetrating through a dispersed particle sample. In this method, the Mie theory of light scattering is used to calculate the particle size distribution. The D(0,5) value means that 50% by volume of all the particles that occur in the material examined are smaller than the value stated.

In a further embodiment of the present invention, boron nitrides having a D(0,5) value of 0.1 μm to 50 μm, preferably of 1 μm to 30 μm, more preferably of 3 μm to 20 μm, are utilized.

Boron nitrides are used with different particle size distributions in the compositions according to the invention. The particle size distribution is described here as the quotient of D(0,1) value and D(0,9) value.

Boron nitrides having a D(0,1)/D(0,9) ratio of 0.0001 to 0.4, preferably of 0.001 to 02, are employed. Particular preference is given to using boron nitrides having a D(0,1)/D(0,9) ratio of 0.01 to 0.15, which corresponds to a very narrow distribution.

In a further embodiment of the present invention, two boron nitrides having different particle size distribution are utilized, which gives rise to a bimodal distribution in the composition.

In the case of use of hexagonal boron nitride, platelets having an aspect ratio (mean platelet diameter divided by the platelet thickness) of ≥2, preferably ≥5, more preferably ≥10, are utilized.

The carbon content of the boron nitrides used is ≤1% by weight, preferably ≤0.5% by weight, more preferably ≤0.1% by weight and most preferably ≤0.05% by weight.

The oxygen content of the boron nitrides used is ≤1% by weight, preferably ≤0.5% by weight and more preferably ≤0.4% by weight.

The proportion of soluble borates in the boron nitrides used is between 0.01% by weight and 1.00% by weight, preferably between 0.05% by weight and 0.50% by weight and more preferably between 0.10% and 0.30% by weight.

The purity of the boron nitrides, i.e. the proportion of pure boron nitride in the additive utilized in each case, is at least 90% by weight, preferably at least 95% by weight and further preferably at least 98% by weight.

The boron nitrides used in accordance with the invention have a surface area, determined by the BET (S. Brunauer, P. H. Emmett, E. Teller) determination method to DIN-ISO 9277 (version DIN-ISO 9277:2014-01), of 0.1 m²/g to 25 m²/g, preferably 1.0 m²/g to 10 m²/g and more preferably 3 m²/g to 9 m²/g.

The bulk density of the boron nitrides is preferably ≤1 g/cm³, more preferably ≤0.8 g/cm³ and most preferably ≤0.6 g/cm³.

Preference is given to using 1% by weight to 60% by weight, preferably 5% by weight to 40% by weight, more preferably 8% by weight to 35% by weight and most preferably 10% by weight to 30% by weight of boron nitride, more preferably without any further fillers, in the compositions.

Examples of commercially usable boron nitrides are Cooling Filler TP 15/400 boron nitride from ESK Ceramics GmbH & Co. KG, HeBoFill® 511, HeBoFill® 501, HeBoFill® 483, HeBoFill® 482 from Henze Boron Nitride Products AG, and CoolFlow CF400, CoolFlow CF500, CoolFlow CF600 and PolarTherm PTI10 from Momentive Performance Materials.

In addition, the boron nitrides may have been surface-modified, which increases the compatibility of the fillers with the composition according to the invention. Suitable modifiers include organic, for example organosilicon, compounds.

Component C

The flow auxiliaries C used are esters of carboxylic acids with diglycerol. Esters based on various carboxylic acids are suitable here. The esters may also be based on different isomers of diglycerol. It is possible to use not only monoesters but also polyesters of diglycerol. It is also possible to use mixtures instead of pure compounds.

Isomers of diglycerol which form the basis of the diglycerol esters used in accordance with the invention are as follows:

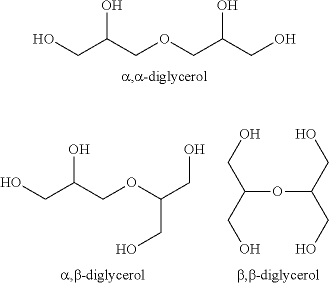

Mono- or polyesterified isomers of these formulae can be used for the diglycerol esters used in accordance with the invention. Mixtures employable as flow auxiliaries are composed of the diglycerol reactants and the ester end products derived therefrom for example having molecular weights of 348 g/mol (monolaurate) or 530 g/mol (dilaurate).

The diglycerol esters present in the composition according to the invention preferably derive from saturated or unsaturated monocarboxylic acids having a chain length of from 6 to 30 carbon atoms. Examples of suitable monocarboxylic acids are caprylic acid (C₇H₁₅COOH, octanoic acid), capric acid (C₉H₁₉COOH, decanoic acid), lauric acid (C₁₁H₂₃COOH, dodecanoic acid), myristic acid (C₁₃H₂₇COOH, tetradecanoic acid), palmitic acid (C₁₅H₃₁COOH, hexadecanoic acid), margaric acid (C₁₆H₃₃COOH, heptadecanoic acid), stearic acid (C₁₇H₄₃COOH, octadecanoic acid), arachidic acid (C₁₉H₃₉COOH, eicosanoic acid), behenic acid (C₂₁H₄₃COOH, docosanoic acid), lignoceric acid (C₂₃H₄₇COOH, tetracosanoic acid), palmitoleic acid (C₁₅H₂₉COOH, (9Z)-hexadeca-9-enoic acid), petroselic acid (C₁₇H₃₃COOH, (6Z)-octadeca-6-enoic acid), elaidic acid (C₁H₃₃COOH, (9E)-octadeca-9-enoic acid), linoleic acid (C₁₇H₃₁COOH, (9Z,12Z)-octadeca-9,12-dienoic acid), alpha- or gamma-linolenic acid (C₁₇H₂₉OOH, (9Z,12Z,15Z)-octadeca-9,12,15-trienoic acid and (6Z,9Z,12Z)-octadeca-6,9,12-trienoic acid), arachidonic acid (C₁₉H₃₁COOH, (5Z,8Z,11Z,14Z)-eicosa-5,8,11,14-tetraenoic acid), timnodonic acid (C₉H₂₉COOH, (5Z,8Z,11Z,14Z,17Z)-eicosa-5,8,11,14,17-pentaenoic acid) and cervonic acid (C₂₁H₃₁COOH, (4Z,7Z,10Z,13Z,16Z,19Z)-docosa-4,7,10,13,16,19-hexaenoic acid). Particular preference is given to lauric acid, palmitic acid and/or stearic acid.

It is particularly preferable that at least one ester of the formula (1) is present as diglycerol ester

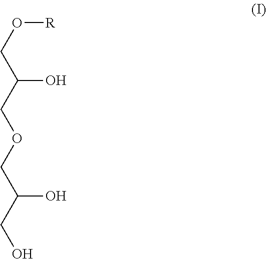

where R=COCₙH₂ₙ₊₁ and/or R=COR′,
where n is an integer and where R′ is a branched alkyl moiety or a branched or unbranched alkenyl moiety and CₙH₂ₙ₊₁ is an aliphatic, saturated linear alkyl moiety.

It is preferable here that n is an integer from 6 to 24, examples of CₙH₂ₙ₊₁ therefore being n-hexyl, n-heptyl, n-octyl, n-nonyl, n-decyl, n-dodecyl, n-tridecyl, n-tetradecyl, n-hexadecyl or n-octadecyl.

It is more preferable that n is from 8 to 18, particularly from 10 to 16, very particularly 12 (diglycerol monolaurate isomer with molar mass 348 g/mol, which is particularly preferred as main compound in a mixture). According to the invention, it is also preferable that the aforementioned ester moieties are present in the case of the other isomers of diglycerol as well.

A mixture of various diglycerol esters can therefore also be used.

The HLB value of diglycerol esters preferably used is at least 6, particularly from 6 to 12, where the HLB value is defined as the “hydrophilic-lipophilic balance”, calculated as follows in accordance with the Griffin method:

HLB=20×(1−M_{lipophilic}/M),

where M_{lipophilic} is the molar mass of the lipophilic component of the diglycerol ester and M is the molar mass of the diglycerol ester.

The amount of diglycerol esters is 0.01% to 3.0% by weight, preferably 0.15% to 1.50% by weight, further preferably 0.20% to 1.0% by weight, more preferably 0.2% to 0.5% by weight.

Component D

Optionally used as component D are up to 30% by weight of inorganic fillers which are preferably selected from the group of the metal oxides, metal carbides, metal nitrides or metal borides, graphite or combinations thereof, for example aluminium oxide, titanium dioxide, magnesium oxide, beryllium oxide, yttrium oxide, hafnium oxide, cerium oxide, zinc oxide, silicon carbide, titanium carbide, boron carbide, zirconium carbide, aluminium carbide, silicon carbide, titanium tungsten carbide, tantalum carbide, aluminium nitride, magnesium silicon nitride, titanium nitride, silicon dioxide, silicon nitride, zirconium boride, titanium diboride, barium sulphate, glass filler and/or aluminium boride.

Particular preference is given to using, as component D, inorganic fillers selected from the group of quartz, graphite and/or glass filler. Very particular preference is given to using graphite.

Quartz-based fillers preferred in accordance with the invention are especially those minerals formed to an extent of more than 97% by weight on the basis of quartz (SiO₂). The particle form is spherical and/or virtually spherical.

Component D comprises finely divided quartz flours which have been produced by iron-free grinding with subsequent wind-sifting from processed quartz sand. A preferred alternative is quartz material which is produced by iron-free classification from amorphous silicon dioxide.

The quartzes used in the compositions according to the invention are characterized by a mean diameter (D(0,5) value) of 2 to 10 μm, preferably of 2.5 to 8.0 μm, further preferably of 3 to 5 μm, and especially preferably of 3 to 4 μm, preference being given to an upper diameter (D(0,95) value) of correspondingly 6 to 34 μm, further preferably of 6.5 to 25.0 μm, even further preferably of 7 to 15 μm, and especially preferably of 8 to 12 μm. The particle distribution (mean diameter) is determined by wind-sifting.

Preferably, the quartzes have a specific BET surface area, determined by nitrogen adsorption in accordance with ISO 9277, of 0.4 to 8.0 m²/g, further preferably of 2.0 to 7.0 m²/g, and especially preferably of 4.4 to 6.0 m²/g.

Further-preferred quartzes have only a maximum of 3% by weight of secondary constituents, with preferred contents of

Al₂O₃<2.0% by weight,

Fe₂O₃<0.05% by weight,

(CaO+MgO)<0.1% by weight,

(Na₂O+K₂O)<0.1% by weight), based in each case on the total weight of the silicate.

Preference is given to using quartzes having a pH of 5.5 to 9.0, further preferably 6.0 to 8.0, measured in accordance with ISO 10390 in aqueous suspension.

They also have oil absorption value according to ISO 787-5 of preferably 20 to 30 g/100 g.

In a preferred embodiment, inorganic fillers, especially quartzes, are used, these having been coated with organosilicon compounds, preference being given to using epoxysilane, methylsiloxane and/or methacryloylsilane slips. Particular preference is given to an epoxysilane slip.

The slip-coating of inorganic fillers is effected by the common methods known to those skilled in the art.

Examples of commercially available quartz flours are Sikron SF300, Sikron SF600, Sikron SF800, Silbond SF600 EST or Amosil FW300 and Amosil FW600 from Quarzwerke GmbH (50226 Frechen, Germany) or Mikro-Dorsilit@ 120 from QUARZSANDE GmbH (4070 Eferding, Austria).

Inorganic fillers usable in accordance with the invention are also glasses consisting of a glass composition selected from the group of the M, E, A, S, R, AR, ECR, D, Q or C glasses, further preference being given to E, S or C glass.

The glass composition can be used in the form of solid glass spheres, hollow glass spheres, glass beads, glass flakes, broken glass and glass fibres, further preference being given to the glass fibres.

The glass fibres can be used in the form ofrowings, chopped glass fibres, ground glass fibres, glass fibre fabrics or mixtures of the aforementioned forms, preference being given to using the chopped glass fibres and the ground glass fibres.

Particular preference is given to using ground glass fibres.

The preferred fibre length of the chopped glass fibres prior to compounding is 0.5 to 10 mm, further preferably 1.0 to 8 mm, most preferably 1.5 to 6 mm.

Chopped glass fibres can be used with different cross sections. Preference is given to using round, elliptical, oval, 8-shaped and flat cross sections, particular preference being given to the round, oval and flat cross sections.

The diameter of round fibres is preferably 5 to 25 μm, further preferably 6 to 20 μm, more preferably 7 to 17 μm.

Preferred flat and oval glass fibres have a cross-sectional ratio of height to width of about 1.0:1.2 to 1.0:8.0, preferably 1.0:1.5 to 1.0:6.0, more preferably 1.0:2.0 to 1.0:4.0.

The flat and oval glass fibres additionally have an average fibre height of 4 μm to 17 μm, preferably of 6 μm to 12 pun and more preferably 6 μm to 8 μm, and an average fibre width of 12 μm to 30 μm, preferably 14 μm to 28 μm and more preferably 16 μm to 26 μm.

In one alternative, the glass fibres have been modified on the surface of the glass fibres with a glass coating slip. Preferred glass coating slips are epoxy-modified, polyurethane-modified and unmodified silane compounds and mixtures of the aforementioned silane compounds.

In another alternative, the glass fibres have not been modified with a glass coating slip.

It is a feature of the glass fibres used that the selection of the fibres is not restricted by the interaction characteristics of the fibres with the polycarbonate matrix.

Strong binding of the glass fibres to the polymer matrix is apparent from the low-temperature fracture surfaces in scanning electron micrographs, with the majority of the broken glass fibres broken at the same level as the matrix and only isolated glass fibres protruding from the matrix. Scanning electron micrographs, in the reverse case of non-binding characteristics, show that the glass fibres in the low-temperature fracture protrude significantly from the matrix or have slid out completely.

In the composition of the invention, ground glass fibres are used in contents of preferably 5.0%-50.0% by weight, more preferably of 10.0%-30.0% by weight and most preferably 15.0%-25.0% by weight.

In a further preferred embodiment, mixtures of the aforementioned glass compositions are used, there being no limitation in terms of form and cross section.

A further group of fillers usable in compositions according to the invention is that of graphites.

Particular preference is given to using expanded graphites, alone or in a mixture with further inorganic fillers. In the expanded graphites, the individual basal planes of the graphite have been driven apart by a specific treatment, which results in an increase in volume of the graphite, preferably by a factor of 200 to 400. The production of expanded graphites is described, inter alia, in documents U.S. Pat. No. 1,137,373 A, U.S. Pat. No. 1,191,383 A and U.S. Pat. No. 3,404,061 A.

Graphites are used in the compositions in the form of fibres, rods, spheres, hollow spheres, platelets, in powder form, in each case either in aggregated or agglomerated form, preferably in platelet form.

The structure in platelet form is understood in the present invention to mean a particle having a flat geometry. Thus, the height of the particles is typically much smaller compared to the width or length of the particles. Flat particles of this kind can in turn be agglomerated or aggregated to form structures.

The height of the primary particles in platelet form is less than 500 nm, preferably less than 200 nm and more preferably less than 100 nm. The small sizes of these primary particles allow the shape of the particles to be bent, curved, wavy or deformed in some other way.

The length dimensions of the particles can be determined by standard methods, for example electron microscopy.

Graphite is used in the thermoplastic compositions according to the invention in amounts of 1.0% to 20.0% by weight, preferably 3.0% to 15.0% by weight, further preferably 5.0% to 12.0% by weight, more preferably 5.0% to 7.5% by weight. Preference is given to choosing the amount of graphite added in the compositions according to the invention such that the compositions exhibit electrical insulation as a core property. Electrical insulation is defined hereinafter as a specific volume resistance of >1E+10 [ohm·m], more preferably >1E+12 [ohm m] and most preferably >1E+13 [ohm·m].

Preference is given in accordance with the invention to using a graphite having a relatively high specific surface area, determined as the BET surface area by means of nitrogen adsorption to ASTM D3037. Preference is given to using graphites having a BET surface area of ≥5 m²/g, more preferably ≥10 m²/g and most preferably ≥18 m²/g in the thermoplastic compositions.

If expanded graphite is present as filler, the D(0,5) of the graphite, determined by sieve analysis to DIN 51938 (DIN 51938:1994-07), is <1.2 mm.

Preferably, the graphites have a particle size distribution, which is characterized by the D(0,9), of at least 1 mm, preferably of at least 1.2 mm, further preferably of at least 1.4 mm and more preferably of at least 1.5 mm.

Likewise preferably, the graphites have a particle size distribution which is characterized by the D(0,5), of at least 400 μm, preferably of at least 600 μm, further preferably of at least 750 μm and more preferably of at least 850 pun.

Preferably, the graphites have a particle size distribution which is characterized by the D(0,1) of at least 100 μm, preferably of at least 150 μm, further preferably of at least 200 μm and more preferably of at least 250 μm.

Particular preference is given to those graphites, in which the stated ranges for the D(0,I), D(0,5) and D(0,9) are combined.

The indices D(0,1), D(0,5) and D(0,9) are determined by sieve analysis based on DIN 51938 (DIN 51938:1994-07).

The graphites used have a density, determined with xylene, in the range from 2.0 g/cm³ to 2.4 g/cm³, preferably from 2.1 g/cm³ to 2.3 g/cm³ and further preferably from 2.2 g/cm³ to 2.27 g/cm³.

The carbon content of the graphites used in accordance with the invention, determined to DIN 51903 (DIN 51903:2012-11) at 800° C. for 20 hours, is preferably ≥90% by weight, further preferably ≥95% by weight and even further preferably ≥98% by weight.

The residual moisture content of the graphites used in accordance with the invention, determined to DIN 51904 (DIN 51904:2012-11) at 110° C. for 8 hours, is preferably ≤5% by weight, further preferably ≤3% by weight and even further preferably ≤2% by weight.

The thermal conductivity of the graphites used in accordance with the invention, prior to processing, is between 250 and 400 W/(m·K) parallel to the basal planes, and between 6 and 8 W/(m·K) at right angles to the basal planes.

The electrical resistivity of the graphites used in accordance with the invention, prior to processing, is about 0.001 ohm·cm preferentially parallel to the basal planes, and less than 0.1 ohm·cm at right angles to the basal planes.

The bulk density of the graphites, determined to DIN 51705 (DIN 51705:2001-06), is typically between 50 g/l and 250 g/l, preferably between 65 g/l and 220 g/l and further preferably between 100 g/l and 200 g/l.

Preference is given to using graphites having a sulphur content of less than 200 ppm in the thermoplastic compositions.

Preference is also given to using graphites having a leachable chlorine ion content of less than 100 ppm in the thermoplastic compositions.

Preference is likewise given to using graphites having a content of nitrates and nitrites of less than 50 ppm in the thermoplastic compositions.

Particular preference is given to using graphites having all these limiting values, i.e. for the sulphur, chlorine ion, nitrate and nitrite contents.

Commercially available graphites usable in the inventive compositions include Ecophit® GFG 5, Ecophit® GFG 50, Ecophit® GFG 200, Ecophit® GFG 350, Ecophit® GFG 500, Ecophit® GFG 900, Ecophit® GFG 1200 from SGL Carbon GmbH, TIMREX® BNB90, TIMREX® KS5-44, TIMREX® KS6, TIMREX® KSI50, TIMREX® SFG44, TIMREX® SFGI50, TIMREX® C-THERM™ 001 and TIMREX® C-THERM™ 011 from TIMCAL Ltd., SC 20 O, SC 4000 O/SM and SC 8000 O/SM from Graphit KropfmQhl AG, Mechano-Cond 1, Mechano-Lube 2 and Mechano-Lube 4G from H.C. Carbon GmbH, Nord-Min 251 and Nord-Min 560T from Nordmann Rassmann GmbH and ASBURY A99, Asbury 230U and Asbury 3806 from Asbury Carbons.

Further Components

Optionally present, in addition, are up to 10.0% by weight, preferably 0.10% to 8.0% by weight, more preferably 0.2% to 3% by weight, of other conventional additives (“further additives”). This group includes flame retardants, anti-drip agents, thermal stabilizers, demoulding agents, antioxidants, UV absorbers, IR absorbers, antistats, optical brighteners, light-scattering agents, colourants such as pigments, including inorganic pigments, carbon black and/or dyes in the amounts customary for polycarbonate. These additives can be added individually or else in a mixture. The group of the further additives does not include glass fillers, quartzes, graphites, boron nitride, or other inorganic fillers, since these are already covered by components B and D. “Further additives” also exclude flow auxiliaries from the group of the diglycerol esters because these are already covered as component C.

Such additives as typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich.

The composition is preferably free of additional demoulding agents, since the diglycerol ester itself acts as a demoulding agent.

The thermal conductivity of the boron nitride-containing compositions is usually ≥0.5 W/(m·K), preferably ≥2 W/(m-K), more preferably ≥3 W/(m·K).

A preferred thermoplastic composition according to the invention comprises
(A) 27.8% to 90% by weight of thermoplastic polymer, further preferably 54.7% to 89.8% by weight, of polycarbonate,
(B) 1% to 60% by weight, further preferably 10.0% to 30.0% by weight, of boron nitride,
(C) 0.01% to 3.0% by weight of diglycerol esters, further preferably 0.1 to 0.5% by weight, of diglycerol esters and
(D) 0% to 30% by weight, preferably 0% to 20% by weight; more preferably 5% to 16% by weight, of at least one further inorganic filler selected from the group of quartz, graphite and/or glass filler.

Particular preference is given in accordance with the invention to a composition comprising, in addition to these components, 0% to 10% by weight of further additives but otherwise no further components.

A further preferred composition according to the invention comprises
(A) 50% to 79.6% by weight of thermoplastic polymer, further preferably polycarbonate,
(B) 10.0% to 30.0% by weight of boron nitride,
(C) 0.01% to 3.0% by weight of diglycerol ester, further preferably 0.1% to 0.5% by weight of diglycerol ester and
(D) 10% to 20% by weight of at least one further inorganic filler, selected from the group of quartz, graphite and/or glass fibre,
(E1) 0.1% to 0.5% by weight of pentaerythritol tetrastearate,
(E2) 0.1% to 0.3% by weight of potassium nonafluoro-1-butanesulphonate and
(E3) 0.1% to 0.5% by weight of polytetrafluoroethylene.

Preferably, this composition does not comprise any further components.

Particularly preferred compositions of the invention consist of
(A) 50% to 79.6% by weight of thermoplastic polymer, further preferably polycarbonate,
(B) 10.0% to 30.0% by weight of boron nitride,
(C) 0.01% to 3.0% by weight of diglycerol ester, further preferably 0.1% to 0.5% by weight of diglycerol ester and
(D) 0% to 20% by weight of at least one further inorganic filler, selected from the group of quartz, graphite and/or glass fibre,
(E) 0 to 10% by weight of further additives, selected from the group of flame retardants, anti-drip agents, thermal stabilizers, demoulding agents, antioxidants, UV absorbers, IR absorbers, antistats, optical brighteners, light-scattering agents, colourants such as pigments, including inorganic pigments, carbon black and/or dyes.

The polymer compositions according to the invention, comprising components A to C, optionally D and optionally further additives, are produced by standard incorporation processes via combination, mixing and homogenization of the individual constituents, especially with the homogenization preferably taking place in the melt under the action of shear forces. If appropriate, combination and mixing prior to the melt homogenization is effected using powder premixes.

It is also possible to use premixes of granules or granules and powders with components B to D and optionally the further additives.

It is also possible to use premixes which have been produced from solutions of the mixture components in suitable solvents, in which case homogenization is optionally effected in solution and the solvent is then removed.

More particularly, it is possible here to introduce components B to D and optionally the further additives of the composition according to the invention into the polycarbonate by known methods or as a masterbatch.

The use of masterbatches is preferable for incorporation of components B to D and optionally the further additives, individually or in a mixture.

Thermoplastic compositions according to the invention can be worked up in a known manner and processed to give any desired shaped bodies.

In this context, the composition according to the invention can be combined, mixed, homogenized and subsequently extruded in customary apparatus such as screw extruders (ZSK twin-screw extruders for example), kneaders or Brabender or Banbury mills. The extrudate can be cooled and comminuted after extrusion. It is also possible to premix individual components and then to add the remaining starting materials individually and/or likewise in a mixture.

It is also possible to combine and mix a premix in the melt in the plastifying unit of an injection-moulding machine. In this case, the melt is converted directly to a shaped body in the subsequent step.

Compositions according to the invention are suitable for production of components of an electrical or electronic assembly, an engine part or a heat exchanger, for example lamp holders, heat sinks and coolers or cooling bodies for printed circuit boards.

Preference is given to using the compositions according to the invention for the production of heat exchangers, for example heat sinks and cooling bodies.

### EXAMPLES

1. Description of Raw Materials and Test Methods

The polycarbonate compositions according to the invention were produced in conventional machines, namely multishaft extruders, by compounding, optionally with addition of additives and other admixtures, at temperatures between 300° C. and 330° C.

The compounds according to the invention for the examples which follow were produced in a BerstorffZE 25 extruder with a throughput of 10 kg/h. The melt temperature was 315° C.

The polycarbonate base A used was a mixture of components A-1 and A-2.

Component A-1:

Linear polycarbonate based on bisphenol A having a melt volume flow rate MVR of 19.0 cm³/10 min (to ISO 1133 (DIN EN ISO 1133-1:2012-03), at a test temperature of 300° C. and load 1.2 kg).

Component A-2:

Linear polycarbonate in powder form, based on bisphenol A having a melt volume flow rate MVR of 19.0 cm³/10 min (to ISO 1133 (DIN EN ISO 1133-1:2012-03), at a test temperature of 300° C. and load 1.2 kg).

Component B-1:

CoolFlow 600 boron nitride from Momentive Performance Materials having a mean particle size of about 16 m, a D10/D90 ratio of about 6/55 and a specific surface area of about 8 m²/g, determined to DIN ISO 9277 (DIN-ISO 9277: 2014-01).

Component B-2:

Carbotherm PCTP3OD boron nitride from Saint-Gobain having a mean particle size of about 180 μm and a specific surface area of about 1 m²/g, determined to DIN ISO 9277 (DIN-ISO 9277: 2014-01).

Component C-1:

Poem DL-100 (diglycerol monolaurate) from Riken Vitamin as flow auxiliary.

Component C-2:

Bisphenol A diphosphate: Reofos® BAPP from Chemtura Corporation as flow auxiliary.

Component D-1:

Amosil FW 600 fused silicon dioxide from Quarzwerke GmbH in Frechen having a mean particle size of about 4 μm, a D10/D90 ratio of about 1.5/10 μm and a specific surface area of about 6 m²/g, determined to DIN ISO 9277 (DIN-ISO 9277: 2014-01).

Component D-2:

SF600 Silicon dioxide from Quarzwerke GmbH in Frechen having a mean particle size of 3 μm and a specific surface area of 4.4 m²/g, determined to DIN ISO 9277 (DIN-ISO 9277: 2014-01).

Component D-3:

Expanded graphite: Ecophit® GFG 1200 from SGL Carbon GmbH with a D(0,5) of 1200 μm.

Component E-1:

Loxiol VPG 861 Pentaerythritol tetrastearate commercially available from Emery Oleochemicals Group.

Component E-2:

Potassium nonafluoro-1-butanesulphonate (Bayowet®C4) from Lanxess, Leverkusen, Germany (CAS No. 29420-49-3).

Component E-3:

Polytetrafluoroethylene: Blendex® B449 (about 50% by weight of PTFE and about 50% by weight of SAN [formed from 80% by weight of styrene and 20% by weight of acrylonitrile]) from Chemtura Corporation.

Vicat softening temperature VST/B50 was determined as a measure of heat distortion resistance to ISO 306 (ISO 306:2013-11) on test specimens of dimensions 80 mm×10 mm×4 nm with a die load of 50 N and a heating rate of 50° C./h with the Coesfeld Eco 2920 instrument from Coesfeld Materialtest.

Modulus of elasticity was measured in accordance with EN ISO 527-1 and -2 on dumbbell specimens injection-moulded by injection on one side, having a core of dimensions 80 mm×10 mm×4 mm at an advance rate of 1 m/min.

Melt volume flow rate (MVR) was determined in accordance with ISO 1133 (DIN EN ISO 1133-1:2012-03, at a test temperature of 300° C., mass 2.16 kg, 4 min) using a Zwick 4106 instrument from Zwick Roell.

Thermal conductivity in injection moulding direction (in-plane) at 23° C. was determined in accordance with ASTM E 1461 on samples of dimensions 80 mm×80 mm×2 mm.

Thermal conductivity in injection moulding direction (through-plane) at 23° C. was determined in accordance with ASTM E 1461 (ASTM E 1461:2013) on samples of dimensions 80 mm×80 mm×2 mm.

Specific volume resistivity was determined in accordance with DIN 60093 (DIN IEC 60093:1993-12).

2. Compositions and Properties Thereof

Undetermined results identified by “n.d.” (not determined).

TABLE 1
Comparative experiment CE1 and compositions IE1 and IE2,
comprising different amounts of diglycerol ester

| | | | CE1 | IE1 | IE2 |
|---|---|---|---|---|---|
| Component | | | | | |
| A-1 | % by | | 62.5 | 62.5 | 62.5 |
| | wt. | | | | |
| A-2 | % by | | 7.5 | 7.2 | 7.0 |
| | wt. | | | | |
| B-1 | % by | | 30.0 | 30.0 | 30.0 |
| | wt. | | | | |
| C-1 | % by | | 0 | 0.3 | 0.5 |
| | wt. | | | | |
| Results | | | | | |
| MVR | ISO | cm³/[10 min] | 11.0 | 31.1 | 60.6 |
| | 1133 | | | | |
| Modulus of | ISO 527 | GPa | 6.4 | 6.3 | 6.4 |
| elasticity | | | | | |
| Vicat- | ISO 306 | ° C. | 149.5 | 140.2 | 136.3 |
| VST/B50 | | | | | |
| Thermal | in-plane | W/[m · K] | 3.0 | n.d. | 3.3 |
| conductivity | | | | | |
| Thermal | through- | W/[m · K] | 0.4 | n.d. | 0.5 |
| conductivity | plane | | | | |

that the MVR measurement was not possible since the material had too low a viscosity for characterization

Table 1 illustrates that the addition of component C-1, i.e. the diglycerol ester, to a mixture of components A and B-1 brings about a distinct improvement in flowability. Modulus of elasticity is independent of the addition of component C-1. Heat distortion resistance, of which the Vicat temperature is an indicator, falls slightly with increasing content of diglycerol ester, but the high-level achieved is sufficient for use in components in the electrical and electronics and IT industries. The amount of diglycerol ester required for a significant increase in the flowability of the boron nitride-containing polycarbonate compositions is small.

TABLE 2
Boron nitride-containing compositions comprising diglycerol esters

| | | | IE3 | IE4 | IE5 | IE6 | IE7 | IE8 | IE9 | IE10 |
|---|---|---|---|---|---|---|---|---|---|---|
| Component | | | | | | | | | | |
| A-1 | % by wt. | | 86.8 | 81.8 | 76.8 | 71.8 | 86.6 | 81.6 | 76.6 | 71.6 |
| A-2 | % by wt. | | 3.0 | 3.0 | 3.0 | 3.0 | 3.0 | 3.0 | 3.0 | 3.0 |
| B-1 | % by wt. | | 10.0 | 15.0 | 20.0 | 25.0 | 10.0 | 15.0 | 20.0 | 25.0 |
| C-1 | % by wt. | | 0.2 | 0.2 | 0.2 | 0.2 | 0.4 | 0.4 | 0.4 | 0.4 |
| Results | | | | | | | | | | |
| MVR | ISO 1133 | cm³/[10 min] | 55.7 | 48.8 | 54.6 | 50.4 | 90.5 | n.d. | 77.4 | 56.0 |
| Modulus of elasticity | ISO 527 | GPa | 3.3 | 3.8 | 4.3 | 5.3 | 3.3 | 3.9 | 4.4 | 5.0 |
| Vicat-VST/B50 | ISO 306 | ° C. | 142.2 | 140.9 | 140.4 | 141.1 | 138.2 | 137.5 | 135.4 | 139.4 |
| Thermal conductivity | in-plane | W/[m · K] | 0.5 | 0.7 | 0.9 | 1.1 | 0.5 | 0.6 | 0.9 | 1.2 |
| Thermal conductivity | through- | W/[m · K] | 0.3 | 0.3 | 0.3 | 0.4 | 0.3 | 0.3 | 0.4 | 0.4 |
| | plane | | | | | | | | | |

Table 2 illustrates that the addition of diglycerol ester, component C-1, to a mixture of components A and B-1 brings about a distinct improvement in flowability, the effect being visible even in the case of high contents of boron nitride. Modulus of elasticity and thermal conductivity are independent of the addition of the diglycerol ester and are determined only by the amount of boron nitride. Heat distortion resistance is affected only slightly by the addition of the diglycerol ester.

TABLE 3

| | | | CE1 | CE3 | IE12 | IE12 | IE13 |
|---|---|---|---|---|---|---|---|
| Component | | | | | | | |
| A-1 | % by wt. | | 47.5 | 47.5 | 50.0 | 50.0 | 76.5 |
| A-2 | % by wt. | | 7.5 | 7.2 | 5.0 | 4.7 | 3.0 |
| B-1 | % by wt. | | 30.0 | 30.0 | 30.0 | 30.0 | 10.0 |
| C-1 | % by wt. | | 0.0 | 0.3 | 0.0 | 0.3 | 0.5 |
| D-1 | % by wt. | | 15.0 | 15.0 | | | |
| D-2 | % by wt. | | | | 15.0 | 15.0 | |
| D-3 | % by wt. | | | | | | 10.0 |
| Results | | | | | | | |
| MVR | ISO | cm³/ | 9.6 | 25.4 | 7.4 | 13.6 | 30.2 |
| | 1133 | [10 min] | | | | | |
| Modulus of | ISO 527 | GPa | 8.3 | 8.7 | 8.9 | 8.2 | 4.0 |
| elasticity | | | | | | | |
| Vicat- | ISO 306 | ° C. | 143.5 | 137.8 | 149.0 | 143.0 | 137.6 |
| VST/B50 | | | | | | | |
| Thermal | in-plane | W/(m · K) | n.d. | n.d. | 3.7 | 3.1 | 3.0 |
| conductivity | | | | | | | |
| Thermal | through- | W/(m · K) | n.d. | n.d. | 0.6 | 0.7 | 0.6 |
| conductivity | plane | | | | | | |

Table 3 illustrates that the addition of component C-1, diglycerol ester, to a mixture of components A, B-1 and various components D (silicone dioxide) brings about a distinct improvement in flowability. The improvement occurs irrespective of the type of silicon dioxide. Modulus of elasticity is independent of the addition of component C-1. Heat distortion resistance falls slightly with increasing content of component C-1 but remains at a sufficiently high level.

TABLE 4

| | | | CE4 | IE14 |
|---|---|---|---|---|
| Component | | | | |
| A-1 | % by wt. | | 57.35 | 63.95 |
| A-2 | % by wt. | | 5 | 5 |
| B-2 | % by wt. | | 30 | 30 |
| C-1 | % by wt. | | | 0.4 |
| C-2 | % by wt. | | 7 | |
| E-1 | % by wt. | | 0.4 | 0.4 |
| E-2 | % by wt. | | 0.15 | 0.15 |
| E-3 | % by wt. | | 0.1 | 0.1 |
| Results | | | | |
| MVR (300° C., | ISO 1133 | cm³/[10 | 13.7 | 49.2 |
| 1.2 kg, 6 min) | | min] | | |
| Modulus of elasticity | ISO 527 | GPa | 5.9 | 5.2 |
| Vicat - VST/B50 | ISO 306 | ° C. | 106.9 | 130.7 |

A comparison of the experiments CE4 and IE14 shows the distinct lowering of heat distortion resistance of the moulding comprising BDP (component C-2).

1.-11. (canceled)

12. A thermoplastic composition comprising
(A) at least one thermoplastic polymer,
(B) boron nitride and
(C) at least one flow auxiliary
characterized in that the flow auxiliary is selected from the group of the diglycerol esters.

13. The thermoplastic composition according to claim 12, characterized in that the diglycerol ester present is an ester of the formula (I) 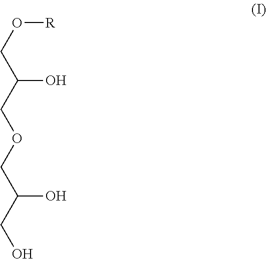
with R=COCₙH₂ₙ₊₁ and/or R=COR′,
where n is an integer and where R′ is a branched alkyl moiety or a branched or unbranched alkenyl moiety and CₙH₂ₙ₊₁ is an aliphatic, saturated linear alkyl moiety.

14. The thermoplastic composition according to claim 12, characterized in that R=COCₙH₂ₙ₊₁ where n is an integer of 6-24.

15. The thermoplastic composition according to claim 12, characterized in that the composition comprises
(A) 27.8% to 90% by weight of thermoplastic polymer,
(B) 1% to 60% by weight of boron nitride,
(C) 0.01% to 3.0% by weight of diglycerol esters.

16. The thermoplastic composition according to claim 12, characterized in that the composition comprises
(A) 55% to 89.8% by weight of thermoplastic polymer,
(B) 10% to 30% by weight of boron nitride,
(C) 0.2% to 0.5% by weight of diglycerol esters.

17. The thermoplastic composition according to claim 12, characterized in that the composition further comprises
at least one further inorganic filler selected from the group consisting of quartz, graphite, glass filler, and combinations thereof.

18. The thermoplastic composition according to claim 12, characterized in that the thermoplastic polymer is polycarbonate.

19. The thermoplastic composition according to claim 12, characterized in that the composition contains 5.0% to 20.0% by weight of inorganic filler as component D, selected from the group consisting of quartz, graphite, glass filler, and combinations thereof.

20. The thermoplastic composition according to claim 12, wherein the composition consists of
(A) 50% to 79.6% by weight of thermoplastic polymer,
(B) 10.0% to 30.0% by weight of boron nitride,
(C) 0.01% to 3.0% by weight of diglycerol ester,
(D) 0% to 20% by weight of at least one further inorganic filler, selected from the group consisting of quartz, graphite, glass filler, and combinations thereof, and
(E) 0% to 10% by weight of further additives, selected from the group consisting of flame retardants, anti-drip agents, thermal stabilizers, demolding agents, antioxidants, UV absorbers, IR absorbers, antistats, optical brighteners, light-scattering agents, colorants, pigments, inorganic pigments, carbon black, dyes, and combinations thereof.

21. A molding produced from the thermoplastic composition according to claim 12.

22. The molding according to claim 21, characterized in that the molding is a heat sink or a cooling body.

23. The thermoplastic composition according to claim 12, characterized in that R=COCₙH₂ₙ₊₁ where n is an integer from 8 to 18.

24. The thermoplastic composition according to claim 12, characterized in that R=COCₙH₂ₙ₊₁ where n is an integer from 10 to 16.

25. The thermoplastic composition according to claim 12, characterized in that R=COCₙH₂ₙ₊₁ where n is 12.
